(19) United States
(12) Patent Application Publication
(10) Pub. No.: US 2023/0067710 A1
(43) Pub. Date: Mar. 2, 2023

(54) TRANSPARENT, FLAME-RETARDANT HIGH-HEAT POLYCARBONATE COMPOSITIONS FOR THIN WALL APPLICATIONS

(71) Applicant: SHPP GLOBAL TECHNOLOGIES B.V., BERGEN OP ZOOM (NL)

(72) Inventors: Mark Adrianus Johannes van der Mee, Etten Leur (NL); Fabrizio Micciche, Breda (NL); Roland Sebastian Assink, Middleburg (NL); Robert Dirk Van de Grampel, Tholen (NL); Tony Farrell, Bergen op Zoom (NL)

(21) Appl. No.: 17/782,273

(22) PCT Filed: Dec. 4, 2020
(86) PCT No.: PCT/IB2020/061537

§ 371 Date: Jun. 3, 2022

Related U.S. Application Data
(60) Provisional application No. 62/944,084, filed on Dec. 5, 2019.

(51) Int. Cl. C08L 69/00

(52) U.S. Cl. CPC C08L 69/00; C08L 2201/02

(57) ABSTRACT

A flame retardant composition comprising: 45.0-99.9 wt % of a high heat copolycarbonate comprising high heat carbonate units derived from high heat bisphenol monomers, and optionally comprising low heat carbonate units, wherein a homopolycarbonate of the low heat carbonate units has a glass transition temperature of up to 150° C. as determined by differential scanning calorimetry as per ASTM D3418 with heating rate of 20° C./min; 0-55 wt % of a homopolycarbonate; 0.1-0.8 wt % of a Ci-i6 alkyl sulfonate salt flame retardant; each based on the total weight of the flame retardant composition wherein a molded sample of the flame retardant composition has a UL 94 rating of V0 at a thickness of 1.5 millimeter, and a transmission of greater than 80%, 85%, or 88% or a haze of less than 2%, or 1%, each of the transmission and haze was determined according ASTM D1003 at a thickness of 1.0 millimeter.

### CROSS-REFERENCE TO RELATED APPLICATIONS

This application claims priority to U.S. Provisional Application No. 62/944,084, filed on Dec. 5, 2019, the content of which is herein incorporated by reference in its entirety.

### BACKGROUND

This disclosure relates to polycarbonate compositions, and in particular to transparent, flame retardant high heat polycarbonate compositions, methods of manufacture, and uses thereof.

Polycarbonates are useful in the manufacture of articles and components for a wide range of applications, from automotive parts to electronic appliances. Because of their broad use, particularly in electronics, it is desirable to provide transparent, flame retardant polycarbonates with improved heat resistance.

There accordingly remains a need in the art for transparent flame retardant polycarbonate compositions having high heat resistance. It would be a further advantage if the compositions had improved flammability ratings at low thicknesses.

### BRIEF DESCRIPTION

The above-described and other deficiencies of the art are met by a flame retardant composition comprising: 45.0-99.9 wt % of a high heat copolycarbonate comprising high heat carbonate units derived from high heat bisphenol monomers comprising 1,1-bis(4-hydroxyphenyl)-3,3,5-trimethyl-cyclohexane, N-phenyl phenolphthalein bisphenol, 4,4′-(1-phenylethylidene)bisphenol, 4,4′(3,3-dimethyl-2,2-dihydro-1H-indene-1,1-diyl)diphenol, 1,1-bis(4-hydroxyphenyl)cyclododecane, 3,8-dihydroxy-5a,10b-diphenyl-coumarano-2′,3′,2,3-coumarane, or a combination thereof, preferably 1,1-bis(4-hydroxyphenyl)-3,3,5-trimethyl-cyclohexane, N-phenyl phenolphthalein bisphenol, or a combination thereof, and optionally comprising low heat carbonate units, wherein a homopolycarbonate of the low heat carbonate units has a glass transition temperature of up to 150° C. as determined by differential scanning calorimetry as per ASTM D3418 with heating rate of 20° C./min; 0-55 wt % of a homopolycarbonate; 0.1-0.8 wt % of a C₁₋₁₆ alkyl sulfonate salt flame retardant; optionally, 2-40 parts per million of an organosulfonic stabilizer of the formula

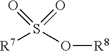

wherein R⁷ is a C₁₋₃₀ alkyl, C₆₋₃₀ aryl, C₇₋₃₀ alkylarylene, C₇₋₃₀ arylalkylene, or a polymer unit derived from a C₂₋₃₂ ethylenically unsaturated aromatic sulfonic acid or its ester, R⁸ is hydrogen, C₁₋₃₀ alkyl; or a group of the formula —S(═O)₂—R⁷; optionally, 0.1-5 wt % of an additive composition, wherein the amount of the high heat copolycarbonate, the C₁₋₁₆ alkyl sulfonate salt flame retardant, the homopolycarbonate, the optional organosulfonic stabilizer and the optional additive composition is based on the total weight of the flame retardant composition, which sums to 100 wt %; wherein a molded sample of the flame retardant composition has a UL 94 rating of V0 at a thickness of 1.5 millimeter, and a transmission of greater than 80%, or greater than 85%, or greater than 88% determined according to ASTM D1003 at a thickness of 1.0 millimeter, or a haze of less than 2%, or less than 1% determined according ASTM D1003 at a thickness of 1.0 millimeter.

In another aspect, a method of manufacture comprises combining the above-described components to form a flame retardant composition.

In yet another aspect, an article comprises the above-described flame retardant composition.

In still another aspect, a method of manufacture of an article comprises molding, extruding, or shaping the above-described flame retardant composition into an article.

The above described and other features are exemplified by the following detailed description, examples, and claims.

### DETAILED DESCRIPTION

Flame retardant (FR) salts such as Rimar salt are commonly used in polycarbonate compositions to reduce the flammability of the polycarbonate compositions. In conventional formulations, low amounts of Rimar salt are added to the polycarbonate compositions, so as to retain transparency in transparent articles and to avoid adversely affecting other properties, such as melt stability. Therefore, by limiting the loading of FR salts such as Rimar salt, this can limit the FR performance of the transparent polycarbonate compositions.

There is a need in the art for compositions having a balance of thin-wall flame retardance, high heat resistance, sufficient flow, and good aesthetics, while maintaining transparency.

To achieve a desirable flame test rating, anti-drip agents are often added to compositions, however, the addition of anti-drip agents can result in a loss of transparency. The inventors hereof discovered that polycarbonate compositions including high heat copolycarbonates that do not include anti-drip agents tolerate a much higher loading of FR salts without compromising percent transmission. Known compositions of high heat copolycarbonates that do not include anti-drip agents and have a conventional loading of FR salts (e.g., 0.08 wt %), while maintaining transparency, fail to demonstrate a desirable flame test rating for thin-walled articles. Therefore, the discovery that compositions including high heat copolycarbonates and a higher than conventional loading of FR salts resulted thin walled articles having a V0 flame test rating while maintaining transparency was a surprising and unexpected result.

Furthermore, the inventors hereof discovered that higher FR loading was tolerated by mixtures of high heat copolycarbonates and polycarbonate homopolymers to achieve improved flame test ratings while maintaining transparency. This result was also surprising, considering that the maximum loadings of FR salts for low heat polycarbonates such as polycarbonate homopolymers (less than 0.1 wt %) and poly(ester-carbonates) while maintaining transparency are much lower, for example, less than 0.1 wt %.

The individual components of the polycarbonate compositions are described in further detail below.

“Polycarbonate” as used herein means a polymer having repeating structural carbonate units of formula (1)

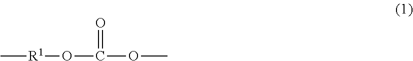

in which at least 60 percent of the total number of R¹ groups contain aromatic moieties and the balance thereof are aliphatic, alicyclic, or aromatic. In an aspect, each R¹ is a C₆₋₃₀ aromatic group, that is, contains at least one aromatic moiety. R¹ can be derived from an aromatic dihydroxy compound of the formula HO—R¹—OH, in particular of formula (2)

HO-A¹-Y¹-A²-OH (2)

wherein each of A¹ and A² is a monocyclic divalent aromatic group and Y¹ is a single bond or a bridging group having one or more atoms that separate A¹ from A². In an aspect, one atom separates A¹ from A². Preferably, each R¹ can be derived from a bisphenol of formula (3)

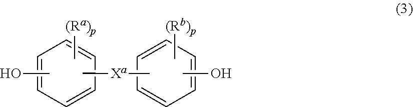

wherein R^{a} and R^{b} are each independently a halogen, C₁₋₁₂ alkoxy, or C₁₋₁₂ alkyl, and p and q are each independently integers of 0 to 4. It will be understood that when p or q is less than 4, the valence of each carbon of the ring is filled by hydrogen. Also in formula (3), X^{a} is a bridging group connecting the two hydroxy-substituted aromatic groups, where the bridging group and the hydroxy substituent of each C₆ arylene group are disposed ortho, meta, or para (preferably para) to each other on the C₆ arylene group. In an aspect, the bridging group X^{a} is single bond, 13 O—, —S—, —S(O)—, —S(O)₂—, —C(O)—, or a C₁₋₆₀ organic group. The organic bridging group can be cyclic or acyclic, aromatic or non-aromatic, and can further comprise heteroatoms such as halogens, oxygen, nitrogen, sulfur, silicon, or phosphorous. The ₁₋₆₀ organic group can be disposed such that the C₆ arylene groups connected thereto are each connected to a common alkylidene carbon or to different carbons of the C₁₋₆₀ organic bridging group. In an aspect, p and q is each 1, and R^{a} and R^{b} are each a C₁₋₃ alkyl group, preferably methyl, disposed meta to the hydroxy group on each arylene group.

The polycarbonates in the flame retardant compositions include a homopolycarbonate (wherein each R¹ in the polymer is the same), a high heat copolycarbonate, and a poly(carbonate-siloxane). In an aspect, he homopolycarbonate in the flame retardant composition is derived from a bisphenol of formula (2), preferably bisphenol A, in which each of A¹ and A² is p-phenylene and Y¹ is isopropylidene in formula (2). The homopolycarbonate can have an intrinsic viscosity, as determined in chloroform at 25° C., of 0.3-1.5 deciliters per gram (dl/gm), preferably 0.45-1.0 dl/gm. The homopolycarbonate can have a weight average molecular weight (Mw) of 10,000-200,000 grams per mol (g/mol), preferably 20,000-100,000 g/mol, as measured by gel permeation chromatography (GPC), using a crosslinked styrene-divinylbenzene column and using polystyrene standards calculated for polycarbonate. GPC samples are prepared at a concentration of 1 mg per ml and are eluted at a flow rate of 1.5 ml per minute. As used herein, “using polystyrene standards and calculated for polycarbonate” refers to measurement of the retention time by GPC, fitting the retention time value to a curve for polystyrene and calculating the molecular weight for polycarbonate. In some aspects, the homopolycarbonate is a bisphenol A homopolycarbonate having an Mw of 18,000-35,000 grams/mole, preferably 20,000-25,000 g/mol; or a bisphenol A homopolycarbonate having a weight average molecular weight of 25,000-35,000 g/mol, preferably 27,000-32,000 g/mol; or a combination thereof, each as measured as described above.

The flame retardant compositions can include a 0-55 wt % of a homopolycarbonate (wherein each R¹ in the polymer is the same). In an aspect, the homopolycarbonate in the flame retardant composition is derived from a bisphenol of formula (2), preferably bisphenol A, in which each of A¹ and A² is p-phenylene and Y¹ is isopropylidene in formula (2). The homopolycarbonate can have an intrinsic viscosity, as determined in chloroform at 25° C., of 0.3-1.5 deciliters per gram (dl/gm), preferably 0.45-1.0 dl/gm. The homopolycarbonate can have a weight average molecular weight (Mw) of 10,000-200,000 grams per mol (g/mol), preferably 20,000-100,000 g/mol, as measured by gel permeation chromatography (GPC), using a crosslinked styrene-divinylbenzene column and using polystyrene standards calculated for polycarbonate. GPC samples are prepared at a concentration of 1 mg per ml and are eluted at a flow rate of 1.5 ml per minute. In some aspects, the homopolycarbonate is a bisphenol A homopolycarbonate having an Mw of 18,000-35,000 grams/mole, preferably 20,000-25,000 g/mol; or a bisphenol A homopolycarbonate having a weight average molecular weight of 25,000-35,000 g/mol, preferably 27,000-32,000 g/mol; or a combination thereof, each as measured as described above. The homopolycarbonate can be present from 0-55 wt %, 0.1-55 wt %, 0-24.5 wt %, or 0.1-24.5 wt %, each based on the total weight of the flame retardant composition. In some aspects, the homopolycarbonate is absent.

The flame retardant compositions include a high heat copolycarbonate that includes high heat carbonate units, optionally together with low heat carbonate units. A combination of different high heat carbonate units or low heat carbonate units can be used.

The low heat carbonate units can be derived from bisphenols of formula (2) as described above wherein X^{a} is a C₁₋₁₈ bridging group. For example, X^{a} can be a C₃₋₆ cycloalkylidene, a C₁₋₆ alkylidene of the formula —C(R^{c})(R^{d})— wherein R^{c} and R^{d} are each independently hydrogen, C₁₋₁₅ alkyl, or a group of the formula —C(═R^{e})— wherein R^{e} is a divalent C₁₋₅ hydrocarbon group. Some illustrative examples of dihydroxy compounds that can be used in the manufacture of the low heat monomer units are described, for example, in WO 2013/175448 A1, US 2014/0295363, and WO 2014/072923. In an aspect, the low heat carbonate unit is derived from bisphenol A, which provides the low heat group of the following formula.

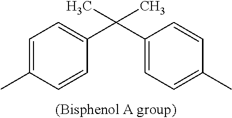

The high heat carbonate units are derived from high heat bisphenol monomers. As used herein, a high heat bisphenol monomer is a monomer where the corresponding homopolycarbonate of the monomer has a glass transition temperature (Tg) of 170° C. or higher, determined per ASTM D3418 with a 20° C./min heating rate. Examples of such high heat bisphenol groups include groups of formulas (6) to (12)

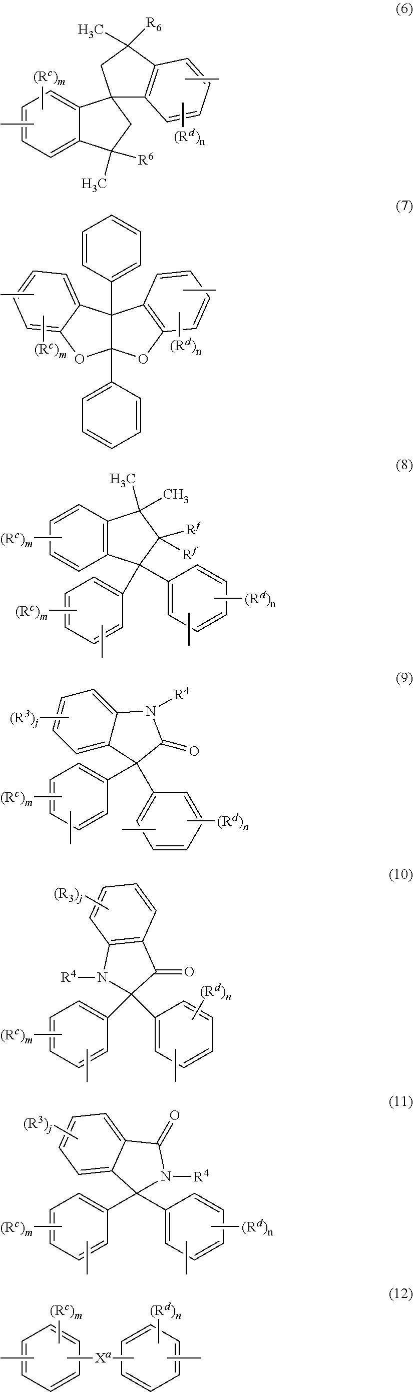

wherein R^{c} and R^{d} are each independently a C₁₋₁₂ alkyl, C₂₋₁₂ alkenyl, C₃₋₈ cycloalkyl, or C₁₋₁₂ alkoxy, each R^{f} is hydrogen or both R_{f} together are a carbonyl group, each R³ is independently C₁₋₆ alkyl, R⁴ is hydrogen, C₁₋₆ alkyl, or phenyl optionally substituted with 1-5 C₁₋₆ alkyl groups, each R⁶ is independently C₁₋₃ alkyl, or phenyl, preferably methyl, X^{a} is a C₆₋₁₂ polycyclic aryl, C₃₋₁₈ mono- or polycycloalkylene, C₃₋₁₈ mono- or polycycloalkylidene, —C(R^{h})(R^{g})— wherein R^{h} is hydrogen, C₁₋₁₂ alkyl, or C₆₋₁₂ aryl and R^{g} is C₆₋₁₀ alkyl, C₆₋₈ cycloalkyl, or C₆₋₁₂ aryl, or -(Q¹)ₓ-G-(Q²)_{y}- wherein Q¹ and Q² are each independently a C₁₋₃ alkylene, G is a C₃₋₁₀ cycloalkylene, x is 0 or 1, and y is 1, and j, m and n are each independently 0-4, or 0 or 1. A combination of high heat bisphenol groups can be used.

In an aspect in formulas (6)-(12), R^{c} and R^{d} are each independently a C₁₋₃ alkyl, or C₁₋₃ alkoxy, each R⁶ is methyl, each R³ is independently C₁₋₃ alkyl, R⁴ is methyl, or phenyl, each R⁶ is independently C₁₋₃ alkyl or phenyl, preferably methyl, X^{a} is a C₆₋₁₂ polycyclic aryl, C₃₋₁₈ mono- or polycycloalkylene, C₃₋₁₈ mono- or polycycloalkylidene, —C(R^{f})(R^{g})— wherein R^{f} is hydrogen, C₁₋₁₂ alkyl, or C₆₋₁₂ aryl and R^{g} is C₆₋₁₀ alkyl, C₆₋₈ cycloalkyl, or C₆₋₁₂ aryl, or -(Q¹)ₓ-G-(Q²)_{y}- group, wherein Q¹ and Q² are each independently a C₁₋₃ alkylene and G is a C₃₋₁₀ cycloalkylene, x is 0 or 1, and y is 0 or 1, and j, m, and n are each independently 0 or 1.

Exemplary high heat bisphenol groups are shown below

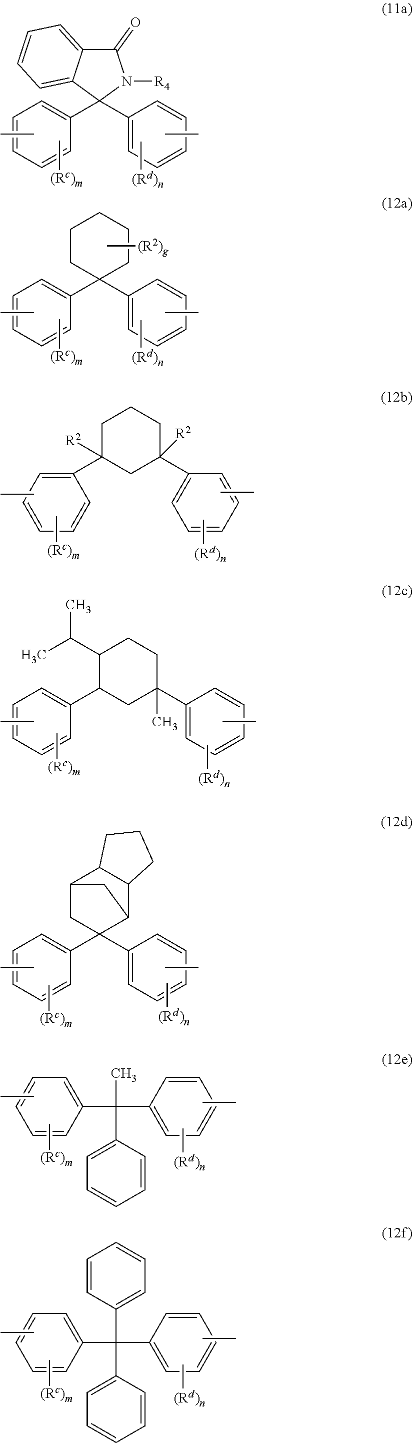

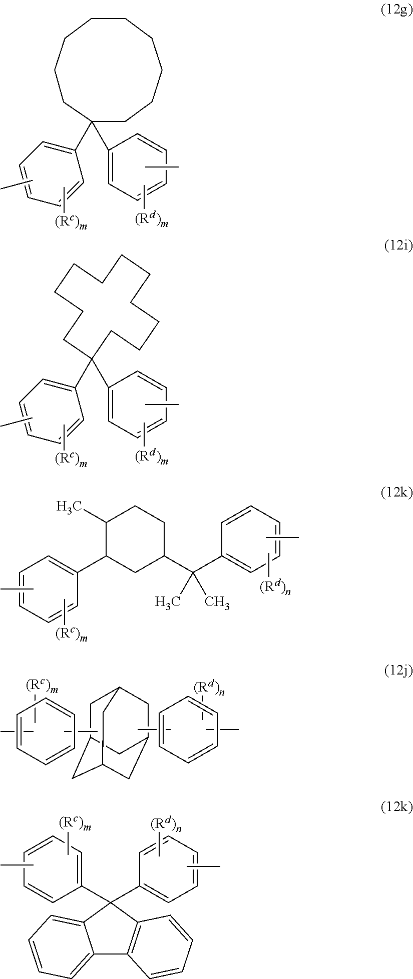

wherein R^{c} and R^{d} are the same as defined for formulas (6) to (12), each R² is independently C₁₋₄ alkyl, m and n are each independently 0-4, each R³ is independently C₁₋₄ alkyl or hydrogen, R⁴ is C₁₋₆ alkyl or phenyl optionally substituted with 1-5 C₁₋₆ alkyl groups, and g is 0-10. In a specific aspect each bond of the bisphenol group is located para to the linking group that is X^{a}. In an aspect, R^{c} and R^{d} are each independently a C₁₋₃ alkyl, or C₁₋₃ alkoxy, each R² is methyl, x is 0 or 1, y is 1, and m and n are each independently 0 or 1.

The high heat bisphenol group is preferably of formula (11a-2) or (12a-2)

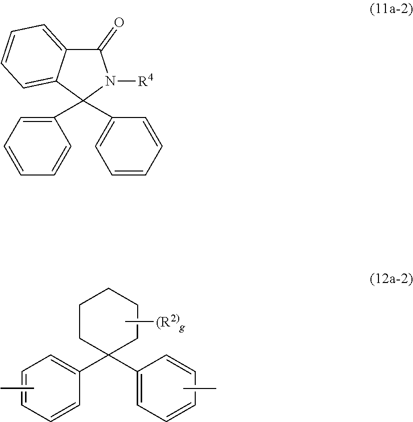

wherein R⁴ is methyl or phenyl, each R² is methyl, and g is 1-4. Preferably, the high heat bisphenol group is derived from N-phenyl phenolphthalein bisphenol (PPPBP, also known as 2-phenyl-3,3′-bis(4-hydroxyphenyl)) or from 1,1-bis(4-hydroxyphenyl)-3,3,5-trimethyl-cyclohexane (BP-TMC).

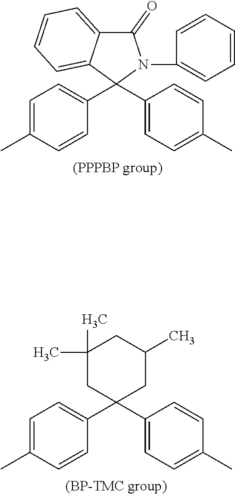

This high heat copolycarbonate can include 0-90 mol %, or 10-80 mol % of low heat aromatic carbonate units, preferably bisphenol A carbonate units; and 10-100 mol %, preferably 20-90 mol % of high heat aromatic carbonate units, even more preferably wherein the high heat carbonate units are derived from 1,1-bis(4-hydroxyphenyl)-3,3,5-trimethyl-cyclohexane, 4,4′-(1-phenylethylidene)bisphenol, 4,4′-(3,3-dimethyl-2,2-dihydro-1H-indene-1,1-diyl)diphenol, 1,1-bis(4-hydroxyphenyl)cyclododecane, 3,8-dihydroxy-5a,10b-diphenyl-coumarano-2′,3′,2,3-coumarane, or a combination thereof, wherein each amount is based on the total moles of the carbonate units, which sums to 100 mol %.

In certain aspects, the high heat copolycarbonate includes 60-80 mol % of bisphenol A carbonate units and 20-40 mol % of high heat aromatic carbonate units derived from 1,1-bis(4-hydroxyphenyl)-3,3,5-trimethyl-cyclohexane, N-phenyl phenolphthalein bisphenol, or a combination thereof, wherein each amount is based on the total moles of the carbonate units, which sums to 100 mol %.

The high heat copolycarbonate can include high heat carbonate units derived from high heat bisphenol monomers comprising N-phenyl phenolphthalein bisphenol. In some aspects, the N-phenyl phenolphthalein bisphenol is present from 15-49 mol %, 20-49 mol %, 25-49 mol %, 30-49 mol %, 35-49 mol %, 40-49 mol %, 15-45 mol %, 15-40 mol %, 15-35 mol %, 15-30 mol %, 15-25 mol %, or 15-20 mol %, each based on the total moles of high heat bisphenol monomer in the flame retardant composition.

The high heat copolycarbonate can be present from 45.0-99.9 wt %, 45.0-85.0 wt %, 45.0-80.0 wt %, 45.0-75.0 wt %, 45.0-70.0 wt %, 45.0-65.0 wt %, 45.0, or 96.7-99.8 wt %, each based on the total weight of the flame retardant composition.

The polycarbonates can be manufactured by processes such as interfacial polymerization and melt polymerization, which are known, and are described, for example, in WO 2013/175448 A1 and WO 2014/072923 A1. An end-capping agent (also referred to as a chain stopper agent or chain terminating agent) can be included during polymerization to provide end groups, for example monocyclic phenols such as phenol, p-cyanophenol, and C₁₋₂₂ alkyl-substituted phenols such as p-cumyl-phenol, resorcinol monobenzoate, and p-and tertiary-butyl phenol, monoethers of diphenols, such as p-methoxyphenol, monoesters of diphenols such as resorcinol monobenzoate, functionalized chlorides of aliphatic monocarboxylic acids such as acryloyl chloride and methacryloyl chloride, and mono-chloroformates such as phenyl chloroformate, alkyl-substituted phenyl chloroformates, p-cumyl-phenyl chloroformate, and toluene chloroformate. Combinations of different end groups can be used. Branched polycarbonate blocks can be prepared by adding a branching agent during polymerization, for example trimellitic acid, trimellitic anhydride, trimellitic trichloride, tris-p-hydroxyphenylethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid. The branching agents can be added at a level of 0.05-2.0 wt %. Combinations comprising linear polycarbonates and branched polycarbonates can be used.

The high heat copolycarbonates comprising high heat carbonate units can have an Mw of 10,000-50,000 g/mol, or 16,000-300,000 g/mol, as measured by gel permeation chromatography (GPC), using a crosslinked styrene-divinylbenzene column and using polystyrene standards calculated for polycarbonate. GPC samples are prepared at a concentration of 1 mg per ml and are eluted at a flow rate of 1.5 ml per minute.

In addition to high heat copolycarbonates and homopolycarbonates, the flame retardant compositions include C₁₋₁₆ alkyl sulfonate salt flame retardants. Examples include potassium perfluorobutane sulfonate (Rimar salt), potassium perfluoroctane sulfonate, and tetraethylammonium perfluorohexane sulfonate. In certain aspects, potassium diphenylsulfone sulfonate or salts such as Na₂CO₃, K₂CO₃, MgCO₃, CaCO₃, and BaCO₃, or fluoro-anion complexes such as Li₃AlF₆, BaSiF₆, KBF₄, K₃AlF₆, KAlF₄, K₂SiF₆, or Na₃AlF₆ can also be used. The C₁₋₁₆ alkyl sulfonate salt flame retardant can be present, for example, from 0.1-0.8 wt %, greater than 0.3 to 0.8 wt %, or 0.4-0.8 wt %, each based on the total weight of the flame retardant composition.

The flame retardant compositions can include N-phenyl phenolphthalein bisphenol as a high heat bisphenol monomer. The N-phenyl phenolphthalein bisphenol can be the only high heat bisphenol monomer present in the high heat copolycarbonate. The N-phenyl phenolphthalein bisphenol can be present in combination with another high heat bisphenol monomer. In some aspects, a ratio of the wt % of the C₁₋₁₆ alkyl sulfonate salt flame retardant to the mol % of N-phenyl phenolphthalein bisphenol is from 0.005-0.017, 0.005-0.015, or 0.005-0.010. The wt % of the C₁₋₁₆ alkyl sulfonate salt flame retardant is based on the total weight of the flame retardant composition and the mol % of N-phenyl phenolphthalein bisphenol is based on the total number of moles of high heat bisphenol monomer.

An additional flame retardant different from the C₁₋₁₆ alkyl sulfonate salt flame retardants can be present. In some aspects, the flame retardant different from the C₁₋₁₆ alkyl sulfonate salt flame retardant is an organophosphorous flame retardant. In the organophosphorus flame retardants that have at least one organic aromatic group, the aromatic group can be a substituted or unsubstituted C₃₋₃₀ group containing one or more of a monocyclic or polycyclic aromatic moiety (which can optionally contain with up to three heteroatoms (N, O, P, S, or Si)) and optionally further containing one or more nonaromatic moieties, for example alkyl, alkenyl, alkynyl, or cycloalkyl. The aromatic moiety of the aromatic group can be directly bonded to the organophosphorous flame retardant, or bonded via another moiety, for example an alkylene group. The aromatic moiety of the aromatic group can be directly bonded to the organophosphorous flame retardant, or bonded via another moiety, for example an alkylene group. In an aspect the aromatic group is the same as an aromatic group of the polycarbonate backbone, such as a bisphenol group (e.g., bisphenol A), a monoarylene group (e.g., a 1,3-phenylene or a 1,4-phenylene), or a combination comprising at least one of the foregoing.

The organophosphorous flame retardant can include a phosphate (P(═O)(OR)₃), phosphite (P(OR)₃), phosphonate (RP(═O)(OR)₂), phosphinate (R₂P(═O)(OR)), phosphine oxide (R₃P(═O)), or phosphine (R₃P), wherein each R in the foregoing organophosphorous flame retardants can be the same or different, provided that at least one R is an aromatic group. A combination of different organophosphorous flame retardants can be used. The aromatic group can be directly or indirectly bonded to the phosphorus, or to an oxygen of the organophosphorous flame retardant (i.e., an ester).

In an aspect the organophosphorous flame retardant is a monomeric phosphate. Representative monomeric aromatic phosphates are of the formula (GO)₃P═O, wherein each G is independently an alkyl, cycloalkyl, aryl, alkylarylene, or arylalkylene group having up to 30 carbon atoms, provided that at least one G is an aromatic group. Two of the G groups can be joined together to provide a cyclic group. In some aspects G corresponds to a monomer used to form the polycarbonate, e.g., resorcinol. Exemplary phosphates include phenyl bis(dodecyl) phosphate, phenyl bis(neopentyl) phosphate, phenyl bis(3,5,5′-trimethylhexyl) phosphate, ethyl diphenyl phosphate, 2-ethylhexyl di(p-tolyl) phosphate, bis(2-ethylhexyl) p-tolyl phosphate, tritolyl phosphate, bis(2-ethylhexyl) phenyl phosphate, tri(nonylphenyl) phosphate, bis(dodecyl) p-tolyl phosphate, dibutyl phenyl phosphate, 2-chloroethyl diphenyl phosphate, p-tolyl bis(2,5,5′-trimethylhexyl) phosphate, 2-ethylhexyl diphenyl phosphate, and the like. A specific aromatic phosphate is one in which each G is aromatic, for example, triphenyl phosphate, tricresyl phosphate, isopropylated triphenyl phosphate, and the like.

Di- or polyfunctional organophosphorous flame retardants are also useful, for example, compounds of the formulas

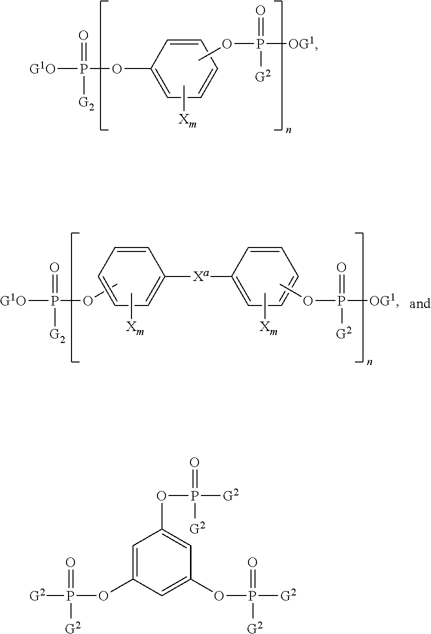

wherein each G¹ is independently a C₁₋₃₀ hydrocarbyl; each G² is independently a C₁₋₃₀ hydrocarbyl or hydrocarbyloxy; X^{a} is as defined in formula (3) or formula (4); each X is independently a bromine or chlorine; m is 0 to 4, and n is 1 to 30. In a specific aspect, X^{a} is a single bond, methylene, isopropylidene, or 3,3,5-trimethylcyclohexylidene.

Specific organophosphorous flame retardants are inclusive of acid esters of formula (13)

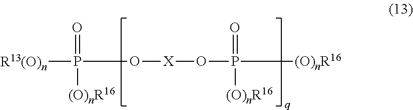

wherein each R¹⁶ is independently C₁₋₈ alkyl, C₅₋₆ cycloalkyl, C₆₋₂₀ aryl, or C₇₋₁₂ arylalkylene, each optionally substituted by C₁₋₁₂ alkyl, specifically by C₁₋₄ alkyl and X is a mono- or poly-nuclear aromatic C₆₋₃₀ moiety or a linear or branched C₂₋₃₀ aliphatic radical, which can be OH-substituted and can contain up to 8 ether bonds, provided that at least one R¹⁶ or X is an aromatic group; each n is independently 0 or 1; and q is from 0.5 to 30. In some aspects each R¹⁶ is independently C₁₋₄ alkyl, naphthyl, phenyl(C₁₋₄)alkylene, aryl groups optionally substituted by C₁₋₄ alkyl; each X is a mono- or poly-nuclear aromatic C₆₋₃₀ moiety, each n is 1; and q is from 0.5 to 30. In some aspects each R¹⁶ is aromatic, e.g., phenyl; each X is a mono- or poly-nuclear aromatic C₆₋₃₀ moiety, including a moiety derived from formula (2); n is one; and q is from 0.8 to 15. In other aspects, each R¹⁶ is phenyl; X is cresyl, xylenyl, propylphenyl, or butylphenyl, one of the following divalent groups

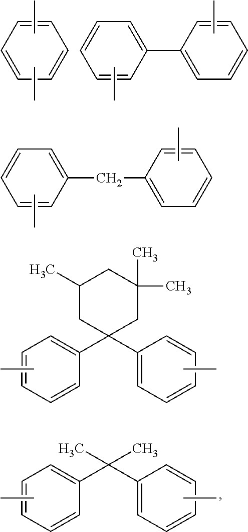

or a combination comprising one or more of the foregoing; n is 1; and q is from 1 to 5, or from 1 to 2. In some aspects at least one R¹⁶ or X corresponds to a monomer used to form the polycarbonate, e.g., bisphenol A, resorcinol, or the like. Organophosphorous flame retardants of this type include the bis(diphenyl) phosphate of hydroquinone, resorcinol bis(diphenyl phosphate) (RDP), and bisphenol A bis(diphenyl) phosphate (BPADP), and their oligomeric and polymeric counterparts.

The organophosphorus flame retardants containing a phosphorus-nitrogen bond can be a phosphazene, phosphonitrilic chloride, phosphorus ester amide, phosphoric acid amide, phosphonic acid amide, phosphinic acid amide, or tris(aziridinyl) phosphine oxide. These flame-retardant additives are commercially available. In an aspect, the organophosphorus flame retardant containing a phosphorus-nitrogen bond is a phosphazene or cyclic phosphazene of the formulas

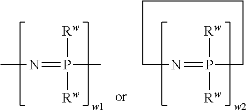

wherein w1 is 3 to 10,000; w2 is 3 to 25, or 3 to 7; and each R^{w} is independently a C₁₋₁₂ alkyl, alkenyl, alkoxy, aryl, aryloxy, or polyoxyalkylene group. In the foregoing groups at least one hydrogen atom of these groups can be substituted with a group having an N, S, O, or F atom, or an amino group. For example, each R^{w} can be a substituted or unsubstituted phenoxy, an amino, or a polyoxyalkylene group. Any given R^{w} can further be a crosslink to another phosphazene group. Exemplary crosslinks include bisphenol groups, for example bisphenol A groups. Examples include phenoxy cyclotriphosphazene, octaphenoxy cyclotetraphosphazene decaphenoxy cyclopentaphosphazene, and the like. In an aspect, the phosphazene has a structure represented by the formula

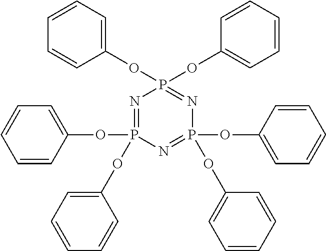 [SMILES: c1ccc(OP2(Oc3ccccc3)=NP(Oc3ccccc3)(Oc3ccccc3)=NP(Oc3ccccc3)(Oc3ccccc3)=N2)cc1]

Commercially available phenoxyphosphazenes having the aforementioned structures are LY202 manufactured and distributed by Lanyin Chemical Co., Ltd, FP-110 manufactured and distributed by Fushimi Pharmaceutical Co., Ltd, and SPB-100 manufactured and distributed by Otsuka Chemical Co., Ltd.

The organosulfonic stabilizer can be an aryl or aliphatic sulfonic acid, including a polymer thereof, an aryl or an aliphatic sulfonic acid anhydride, or an aryl or aliphatic ester of an aryl or aliphatic sulfonic acid, or a polymer thereof. In particular, the organosulfonic stabilizer is a C₁₋₃₀ alkyl sulfonic acid, a C₆₋₃₀ aryl sulfonic acid, a C₇₋₃₀ alkylarylene sulfonic acid, a C₇₋₃₀ arylalkylene sulfonic acid, or an aromatic sulfonic acid polymer; an anhydride of a C₁₋₃₀ alkyl sulfonic acid, a C₆₋₃₀ aryl sulfonic acid, a C₇₋₃₀ alkylarylene sulfonic acid, or a C₇₋₃₀ arylalkylene sulfonic acid; or a C₆₋₃₀ aryl ester of a C₁₋₃₀ alkyl sulfonic acid, a C₆₋₃₀ aryl sulfonic acid, a C₇₋₃₀ alkylarylene sulfonic acid, a C₇₋₃₀ arylalkylene sulfonic acid, or an aromatic sulfonic acid polymer; or a C₁₋₃₀ aliphatic ester of a C₁₋₃₀ alkyl sulfonic acid, a C₆₋₃₀ aryl sulfonic acid, a C₇₋₃₀ alkylarylene sulfonic acid, a C₇₋₃₀ arylalkylene sulfonic acid, an aromatic sulfonic acid polymer, or a combination thereof.

When present, the organosulfonic stabilizers are preferably represented by formula (14)

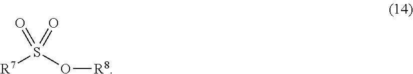

In formula (14), R⁷ is each independently a C₁₋₃₀ alkyl, C₆₋₃₀ aryl, C₇₋₃₀ alkylarylene, C₇₋₃₀ arylalkylene, or a polymer unit derived from a C₂₋₃₂ ethylenically unsaturated aromatic sulfonic acid or its corresponding C₁₋₃₂ alkyl ester. The C₂₋₃₂ ethylenically unsaturated aromatic sulfonic acid can be of the formula

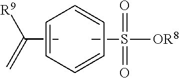

wherein R⁹ is hydrogen or methyl, and R⁸ is as defined in formula (14). Preferably the ethylenically unsaturated group and the sulfonic acid or ester group are located para on the phenyl ring.

Further in formula (14), R⁸ is hydrogen; or R⁸ is C₁₋₃ alkyl; or R⁸ is a group of the formula —S(═O)₂—R⁷. When R⁸ is a group of the formula —S(═O)₂—R⁷, each R⁷ in the compound of formula (8) can be the same or different, but preferably each R⁷ is the same.

In an aspect in formula (14), R⁷ is a C₆₋₁₂ aryl, C₇₋₂₄ alkylarylene, or a polymer unit derived from a C₂₋₁₄ ethylenically unsaturated aromatic sulfonic acid or its ester; and R⁸ is hydrogen, C₁₋₂₄ alkyl, or a group of the formula —S(═O)₂—R⁷ wherein R⁷ is a C₆₋₁₂ aryl or C₇₋₂₄ alkylarylene.

In a preferred aspect, R⁷ is a C₇₋₁₀ alkylarylene or a polymer unit derived from a C₂₋₁₄ ethylenically unsaturated aromatic sulfonic acid, and R⁸ is a hydrogen, C₁₋₂₅ alkyl, or a group of the formula —S(═O)_{2—R}⁷ wherein R⁷ is a C₇₋₁₀ alkylarylene. In a specific embodiment, R⁷ is a C₇₋₁₀ alkylarylene and R⁸ is a hydrogen or C₁₋₆ alkyl. In still another embodiment, R⁷ is a C₇₋₁₀ alkylarylene and R⁸ is a hydrogen or C₁₂₋₂₅ alkyl, or R⁸ is a C₁₄₋₂₀ alkyl.

In an aspect, R⁷ is a polymer unit derived from a C₂₋₁₄ ethylenically unsaturated aromatic sulfonic acid, preferably p-styrene sulfonic acid or para-methyl styrene sulfonic acid, such that in formula (14) R⁸ is hydrogen.

In an aspect, the organosulfonic stabilizer is a C₁₋₁₀ alkyl ester of a C₇₋₁₂ alkylarylene sulfonic acid, preferably of p-toluene sulfonic acid. More preferably the stabilizer is a C₁₋₆ alkyl ester of p-toluene sulfonic acid, and even more preferably is butyl tosylate.

In another aspect, the organosulfonic stabilizer is an anhydride of a C₇₋₁₂ alkylarylene sulfonic acid, preferably para-toluene sulfonic anhydride as shown in Table 13.

In still another aspect, R⁷ is a C₁₁₋₂₄ alkylarylene sulfonic acid, and R⁸ is hydrogen. Alternatively, R⁷ is a C₁₆₋₂₂ alkylarylene sulfonic acid, and R⁸ is hydrogen.

The organosulfonic stabilizer can be used in an amount of 2 to 40 ppm, more preferably 2 to 20 ppm, still more preferably 4 to 15 ppm, or 4 to 10 ppm, or 4 to 8 ppm by weight based on the total weight composition.

The flame retardant compositions can further comprise an additive composition that includes various additives ordinarily incorporated into polymer compositions of this type, with the proviso that the additive(s) are selected so as to not significantly adversely affect the desired properties of the flame retardant composition, in particular heat resistance, transparency, and flame retardance. Combinations of additives can be used. The additive composition can include an impact modifier, flow modifier, particulate filler (e.g., a particulate polytetrafluoroethylene (PTFE), glass, carbon, mineral, or metal), antioxidant, heat stabilizer, light stabilizer, ultraviolet (UV) light stabilizer, UV absorbing additive, plasticizer, lubricant, release agent (such as a mold release agent), antistatic agent, anti-fog agent, antimicrobial agent, colorant (e.g., a dye or pigment), surface effect additive, radiation stabilizer, a flame retardant different from the C₁₋₁₆ alkyl sulfonate salt flame retardant, an anti-drip agent, or a combination thereof. In some aspects, an anti-drip agent is absent from the flame retardant compositions.

There is considerable overlap among plasticizers, lubricants, and mold release agents, which include, for example, phthalic acid esters (e.g., octyl-4,5-epoxy-hexahydrophthalate), tris-(octoxycarbonylethyl)isocyanurate, di- or polyfunctional aromatic phosphates (e.g., resorcinol tetraphenyl diphosphate (RDP), the bis(diphenyl) phosphate of hydroquinone and the bis(diphenyl) phosphate of bisphenol A); poly-alpha-olefins; epoxidized soybean oil; silicones, including silicone oils (e.g., poly(dimethyl diphenyl siloxanes); fatty acid esters (e.g., C₁₋₃₂alkyl stearyl esters, such as methyl stearate and stearyl stearate and esters of stearic acid such as pentaerythritol tetrastearate, glycerol tristearate (GTS), and the like), waxes (e.g., beeswax, montan wax, paraffin wax, or the like), or combinations comprising at least one of the foregoing plasticizers, lubricants, and mold release agents. These are generally used in amounts of 0.01-5 wt %, based on the total weight of total weight of the flame retardant composition, which sums to 100 wt %.

Antioxidant additives include organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite; alkylated monophenols or polyphenols; alkylated reaction products of polyphenols with dienes, such as tetrakis[methylene(3,5-di-tert-butyl-4-hydroxyhydrocinnamate)] methane; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis 3-(3,5-di-tert-butyl-4-hydroxyphenyl)propionate; amides of beta-(3,5-di-tert-butyl-4-hydroxyphenyl)-propionic acid, or combinations comprising at least one of the foregoing antioxidants. Antioxidants are used in amounts of 0.01-0.2, or 0.01-0.1 parts by weight, based on the total weight of the flame retardant composition, which sums to 100 wt %.

The additive composition can be present from 0.1-5 wt %, 0.1-3 wt %, 0.1-2 wt %, 0.1-1 wt %, 0.1-0.5 wt %, or 0.1-0.2 wt %, each based on the total weight of the flame retardant composition.

The flame retardant composition is essentially free of chlorine and bromine. “Essentially free of chlorine and bromine” refers to materials produced without the intentional addition of chlorine or bromine or chlorine or bromine containing materials. It is understood however that in facilities that process multiple products a certain amount of cross contamination can occur resulting in bromine or chlorine levels typically on the parts per million by weight scale. With this understanding it can be readily appreciated that “essentially free of bromine and chlorine” can be defined as having a bromine or chlorine content of less than or equal to 100 parts per million by weight (ppm), less than or equal to 75 ppm, or less than or equal to 50 ppm. In some aspects, “essentially free of bromine and chlorine” means a total bromine and chlorine content of less than or equal to 100 parts per million by weight, or less than or equal to 75 ppm, or less than or equal to 50 ppm. When this definition is applied to the flame retardant it is based on the total weight of the flame retardant. When this definition is applied to the flame retardant composition it is based on the total parts by weight of the flame retardant composition.

The flame retardant compositions can be manufactured by various methods. For example, powdered polycarbonates, flame retardant, or other optional components are first blended, optionally with fillers in a HENSCHEL-Mixer high speed mixer. Other low shear processes, including but not limited to hand mixing, can also accomplish this blending. The blend is then fed into the throat of a twin-screw extruder via a hopper. Alternatively, at least one of the components, for example the reinforcing filler, can be incorporated into the composition by feeding directly into the extruder at the throat or downstream through a sidestuffer. Additives can also be compounded into a masterbatch with a desired polymeric polymer and fed into the extruder. The extruder is generally operated at a temperature higher than that necessary to cause the composition to flow. The extrudate is immediately quenched in a water bath and pelletized. The pellets so prepared can be one-fourth inch long or less as desired. Such pellets can be used for subsequent molding, shaping, or forming.

The transparent flame retardant compositions can be produced by manipulation of the process used to manufacture the flame retardant composition. One example of such a process to produce transparent polycarbonate compositions is described in U.S. Patent Application No. 2003/0032725.

A molded sample of the flame retardant composition can have a transmission of higher than 80%, or higher than 85%, or higher than 88%, as determined according to ASTM D1003 at a thickness of 1.0 millimeter.

A molded sample of the flame retardant composition can have a haze of less than 2%, or less than 1%, as determined according to ASTM D1003 at a thickness of 1.0 millimeter.

A molded sample of the flame retardant composition can have a heat deflection temperature greater than 155° C., preferably greater than 160° C., more preferably greater than 165° C., most preferably greater than 170° C., determined according to the ISO-75 standard using a 5.5 joule hammer on 4 millimeter-thick sample bar and a load of 1.8 megapascals.

A molded sample of the flame retardant composition can have a flame test rating of V0, as measured according to UL-94 at a thickness of 1.5 millimeter.

The flame retardant compositions can be used in articles including a molded article, a thermoformed article, an extruded film, an extruded sheet, one or more layers of a multi-layer article, a substrate for a coated article, or a substrate for a metallized article. Optionally, the article has no significant part distortion or discoloration when the article is subjected to a secondary operation such as over-molding, lead-free soldering, wave soldering, low temperature soldering, or coating, or a combination thereof. The articles can be partially or completely coated with, e.g., a hard coat, a UV protective coat, an anti-refractive coat, an anti-reflective coat, a scratch resistant coat, or a combination thereof, or metallized.

Exemplary articles include a lens, a light guide, a waveguide, a collimator, an optical fiber, a window, a door, a visor, a display screen, an electronic device, a scientific or medical device, a safety shield, a fire shield, wire or cable sheathing, a mold, a dish, a tray, a screen, an enclosure, glazing, packaging, a gas barrier, an anti-fog layer, or an anti-reflective layer.

This disclosure is further illustrated by the following examples, which are non-limiting.

### EXAMPLES

The following components are used in the examples. Unless specifically indicated otherwise, the amount of each component is in wt %, based on the total weight of the composition.

The materials shown in Table 1 were used.

TABLE 1

| Compo- | | |
|---|---|---|
| nent | Description (Trade name) | Source |
| PPPBP- | Poly (N-Phenylphenolphthaleinyl bisphenol, | SABIC |
| BPA | 2,2-bis(4-hydro) carbonate - bisphenol A | |
| | carbonate), 33 mol % PPPBP units, Mw = | |
| | 22,000-24,000 g/mol determined via GPC | |
| | using polystyrene standards calculated for | |
| | polycarbonate, made by interfacial | |
| | polymerization, PCP end-capped, PDI = | |
| | 2-3 | |
| PPC | Poly(bisphenol A carbonate-bisphenol A | SABIC |
| | phthalate) having 19-21 wt % bisphenol | |
| | A carbonate units and 79-81 wt % bisphenol | |
| | A phthalate groups with an isophthalate: | |
| | terephthalate ratio of 93:7; Tg = | |
| | 174° C.; Mw = 27,000-29,000 determined | |
| | via GPC using polystyrene standards and | |
| | calculated for polycarbonate | |
| PC | Linear poly(bisphenol A carbonate); Mw = | SABIC |
| | 20,000-22,000 g/mol determined via GPC | |
| | using polystyrene standards and calculated | |
| | for polycarbonate; produced by interfacial | |
| | polymerization | |
| Rimar | Potassium perfluorobutane sulfonate | 3M |
| KSS | Potassium diphenylsulfone sulfonate | Sloss |
| | | Inds. |
| PETS | Pentaerythritol tetrastearate, >90% esterified | Faci |
| PEPQ | Aryl phosphonite, CAS No. 119345-01-6 | Clariant |
| Phos- | Tris(2,4-di-tert-butylphenyl) phosphite | BASF |
| phite | (IRGAFOS 168) | |
| AO | Hindered phenolic antioxidant (IRGANOX | BASF |
| | 1076) | |

The testing samples were prepared as described below and the following test methods were used.

All powder additives were combined together with the polycarbonate powder(s), using a paint shaker, and fed through one feeder to an extruder. Extrusion for all combinations was performed on a 25 mm twin screw extruder, using a melt temperature of 270-320° C. and 300 revolutions per minute (rpm), then pelleted. The pellets were dried for 4-6 hours at 135° C. Dried pellets were injection molded at temperatures of 270-320° C. to form specimens for most of the tests below.

Heat distortion temperatures were measured in accordance with the ISO-75 standard with a 5.5 J hammer, using the flat side of 4 mm-thick ISO bars and a load of 1.8 MPa (A/f).

Melt volume rates were measured in accordance with the ISO-1133 standard at 300° C., using 1.2 kg of force for 300 seconds (s). The pellets were dried for 3 hours at 120° C. before testing.

Vicat softening temperatures were measured on 4 mm-thick ISO bars in accordance with the ISO-306 standard at a load of 50 N and a speed of 120° C. per hour (B120).

The percent transmission was acquired on 1.0-mm-thick parts on a HAZE-GUARD plus from BYK-Gardner instruments according to ASTM D1003.

The percent haze was acquired on 1.0 mm-thick parts on a HAZE-GUARD plus from BYK-Gardner instruments according to ASTM D1003.

Flammability tests were performed at 1.5 mm, in accordance with the Underwriter's Laboratory (UL) UL 94 standard. In some cases, a second set of 5 bars was tested to give an indication of the robustness of the rating. In this report the following definitions are used as shown in Table 2. Total flame-out-times for all 5 bars (FOT=t1+t2) were determined. V-ratings were obtained for every set of 5 bars.

TABLE 2

| | t₁ and/or t₂ | 5-bar FOT | burning drips |
|---|---|---|---|
| V0 | <10 | <50 | no |
| V1 | <30 | <250 | no |
| V2 | <30 | <250 | yes |
| N.R. (no rating) | >30 | >250 | |

The formulations and properties of Comparative Examples 1-9 and Examples 1-4 are shown in Table 3.

TABLE 3

| Component | Unit | 1* | 2* | 3* | 4* | 5* | 6* | 7* | 8* | 9* | 1 | 2 | 3 | 4 |
|---|---|---|---|---|---|---|---|---|---|---|---|---|---|---|
| PPPBP-BPA | wt % | | | | 99.41 | 99.26 | 99.11 | 99.46 | 99.36 | 99.26 | 99.16 | 99.06 | 98.96 | 98.76 |
| PPC | wt % | 99.41 | 99.26 | 99.11 | | | | | | | | | | |
| PETS | wt % | 0.3 | 0.3 | 0.3 | 0.3 | 0.3 | 0.3 | 0.3 | 0.3 | 0.3 | 0.3 | 0.3 | 0.3 | 0.3 |
| AO | wt % | 0.06 | 0.06 | 0.06 | 0.06 | 0.06 | 0.06 | 0.06 | 0.06 | 0.06 | 0.06 | 0.06 | 0.06 | 0.06 |
| Phosphite | wt % | 0.08 | 0.08 | 0.08 | 0.08 | 0.08 | 0.08 | 0.08 | 0.08 | 0.08 | 0.08 | 0.08 | 0.08 | 0.08 |
| KSS | wt % | 0.15 | 0.3 | 0.45 | 0.15 | 0.3 | 0.45 | | | | | | | |
| Rimar | wt % | | | | | | | 0.1 | 0.2 | 0.3 | 0.4 | 0.5 | 0.6 | 0.8 |
| Total | wt % | 100.00 | 100.00 | 100.00 | 100.00 | 100.00 | 100.00 | 100.00 | 100.00 | 100.00 | 100.00 | 100.00 | 100.00 | 100.00 |

Properties

| | | | | | | | | | | | | | | |
|---|---|---|---|---|---|---|---|---|---|---|---|---|---|---|
| MVR | cm³/ | 21 | 22 | 22 | 20 | 21 | 21 | 28 | 31 | 30 | 32 | 28 | 27 | 28 |
| | 10 min | | | | | | | | | | | | | |
| VICAT | ° C. | 152 | 151 | 151 | 191 | 191 | 190 | 191 | 189 | 189 | 188 | 189 | 189 | 190 |
| Transmission, | % | 92 | 92 | 92 | 89 | 88 | 91 | 88 | 88 | 88 | 88 | 88 | 89 | 88 |
| 1 mm | | | | | | | | | | | | | | |
| Haze, 1.0 mm | % | 0.9 | 1 | 1.2 | 0.7 | 1 | 1 | 0.6 | 0.5 | 0.4 | 0.5 | 0.7 | 0.7 | 0.7 |

UL 94, 1.5 mm, 23° C., 48 h

| | | | | | | | | | | | | | | |
|---|---|---|---|---|---|---|---|---|---|---|---|---|---|---|
| t1 | sec | 23 | 42 | 64 | 20 | 15 | 13 | 5 | 5 | 5 | 6 | 5 | 7 | 6 |
| t2 | sec | 20 | 31 | 19 | 20 | 20 | 16 | 22 | 17 | 11 | 9 | 12 | 14 | 12 |
| no. burning | | 4 | 4 | 5 | 5 | 3 | 2 | 2 | 2 | 1 | 0 | 0 | 0 | 0 |
| drips | | | | | | | | | | | | | | |
| Rating | | V2 | V2 | V2 | V2 | V2 | V2 | V2 | V2 | V2 | V0 | V0 | V0 | V0 |

*Comparative Examples

Comparative Examples 1-6 show that the combination of PPPBP-BPA and KSS or PPC and KSS failed to provide a UL-94 flame test rating of V0 at a 1.5 mm thickness. Comparative Examples 7-9 show that the combination of PPPBP-BPA with Rimar salt (0.1-0.3 wt %) also failed to provide a UL-94 flame test rating of V0 at a 1.5 mm thickness. However, as shown in Examples 1-4 show that the combination of PPPBP-BPA with Rimar salt (0.4-0.8 wt %) resulted in a UL-94 flame test rating of V0 at a 1.5 mm thickness.

The formulations and properties of Comparative Examples 10-20 are shown in Table 4.

TABLE 4

| Component | Unit | 10* | 11* | 12* | 13* | 14* | 15* | 16* | 17* | 18* | *19 | *20 |
|---|---|---|---|---|---|---|---|---|---|---|---|---|
| PPPBP-BPA | wt % | | | | | | | 74.76 | 49.6 | 24.5 | | |
| PC | wt % | | | | | | | 24.5 | 49.66 | 74.76 | 99.26 | 99.46 |
| PPC | wt % | 99.46 | 99.36 | 99.26 | 99.16 | 98.96 | 98.76 | | | | | |
| PETS | wt % | 0.3 | 0.3 | 0.3 | 0.3 | 0.3 | 0.3 | 0.3 | 0.3 | 0.3 | 0.3 | 0.3 |
| AO | wt % | 0.06 | 0.06 | 0.06 | 0.06 | 0.06 | 0.06 | 0.06 | 0.06 | 0.06 | 0.06 | 0.06 |
| Phosphite | wt % | 0.08 | 0.08 | 0.08 | 0.08 | 0.08 | 0.08 | 0.08 | 0.08 | 0.08 | 0.08 | 0.08 |
| Rimar | wt % | 0.1 | 0.2 | 0.3 | 0.4 | 0.6 | 0.8 | 0.3 | 0.3 | 0.3 | 0.3 | 0.1 |
| Total | wt % | 100.00 | 100.00 | 100.00 | 100.00 | 100.00 | 100.00 | 100.00 | 100.00 | 100.00 | 100.00 | 100.00 |

Properties

| | | | | | | | | | | | | |
|---|---|---|---|---|---|---|---|---|---|---|---|---|
| MVR | cm³/ | 18 | 21 | 22 | 22 | 21 | 21 | 35 | 54 | 70 | 112 | 100 |
| | 10 min | | | | | | | | | | | |
| VICAT | ° C. | 155 | 152 | 151 | 151 | 151 | 151 | 178 | 166 | 153 | 143 | 143 |
| Transmission, | % | 92 | 91 | 87 | 83 | 74 | 67 | 91 | 92 | 89 | 85 | 93 |
| 1 mm | | | | | | | | | | | | |
| Haze, 1.0 mm | % | 0.7 | 2.5 | 49.9 | 79.3 | 96.4 | 101 | 0.4 | 0.4 | 30.2 | 68.4 | 0.3 |

UL94, 1.5 mm, 23° C., 48 h

| | | | | | | | | | | | | |
|---|---|---|---|---|---|---|---|---|---|---|---|---|
| t1 | sec | 9 | 8 | 8 | 8 | 12 | 8 | 10 | 8 | 10 | 15 | 13 |
| t2 | sec | 29 | 9 | 15 | 9 | 18 | 12 | 7 | 19 | 16 | 26 | 21 |
| no. burning drips | | 38 | 18 | 23 | 17 | 29 | 20 | 17 | 26 | 26 | 41 | 33 |
| Rating | | V2 | V0 | V0 | V0 | V0 | V0 | V2 | V2 | V2 | V2 | V2 |

*Comparative Examples

Comparative Examples 10-15 show that the combination of PPC and Rimar salt at loadings ranging from 0.1 to 0.8 wt % failed to provide a UL-94 test rating of V0 at a thickness of 1.5 mm and either a percent haze of less than 1% at 1 mm thickness or a percent transmission of greater than 80% at 1 mm thickness. Comparative Examples 16-18 show that the combination of PPPBP-BPA and BPA homopolycarbonate (“PC”) fail to provide a UL-94 test rating of V0 at a thickness of 1.5 mm. BPA homopolycarbonate, when used alone without PPPBP-BPA failed to provide a UL-94 test rating of VO at a thickness of 1.5 mm and either a percent haze of less than 1% at 1 mm thickness or a percent transmission of greater than 80% at 1 mm thickness (Comparative Examples 19-20). Therefore, as demonstrated in Tables 3 and 4, the combination of a high-heat polycarbonate and Rimar salt (i.e., 0.4-0.8 wt %) provide the desired combination of properties.

This disclosure further encompasses the following aspects.

Aspect 1. A flame retardant composition comprising: 45.0-99.9 wt % of a high heat copolycarbonate comprising high heat carbonate units derived from high heat bisphenol monomers comprising 1,1-bis(4-hydroxyphenyl)-3,3,5-trimethyl-cyclohexane, N-phenyl phenolphthalein bisphenol, 4,4′-(1-phenylethylidene)bisphenol, 4,4′-(3,3-dimethyl-2,2-dihydro-1H -indene-1,1-diyl)diphenol, 1,1-bis(4-hydroxyphenyl)cyclododecane, 3,8-dihydroxy-5a,10b-diphenyl-coumarano-2′,3′,2,3-coumarane, or a combination thereof, preferably 1,1-bis(4-hydroxyphenyl)-3,3,5-trimethyl-cyclohexane, N-phenyl phenolphthalein bisphenol, or a combination thereof, and optionally comprising low heat carbonate units, wherein a homopolycarbonate of the low heat carbonate units has a glass transition temperature of up to 150° C. as determined by differential scanning calorimetry as per ASTM D3418 with heating rate of 20° C./min; 0-55 wt % of a homopolycarbonate; 0.1-0.8 wt % of a C₁₋₁₆ alkyl sulfonate salt flame retardant; optionally, 2-40 parts per million of an organosulfonic stabilizer of the formula

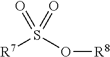

wherein R⁷ is a C₁₋₃₀ alkyl, C₆₋₃₀ aryl, C₇₋₃₀ alkylarylene, C₇₋₃₀ arylalkylene, or a polymer unit derived from a C₂₋₃₂ ethylenically unsaturated aromatic sulfonic acid or its ester, R⁸ is hydrogen, C₁₋₃₀ alkyl; or a group of the formula —S(═O)₂—R⁷; optionally, 0.1-5 wt % of an additive composition, wherein the amount of the high heat copolycarbonate, the C₁₋₁₆ alkyl sulfonate salt flame retardant, the homopolycarbonate, the optional organosulfonic stabilizer and the optional additive composition is based on the total weight of the flame retardant composition, which sums to 100 wt %; wherein a molded sample of the flame retardant composition has a UL 94 rating of V0 at a thickness of 1.5 millimeter, and a transmission of greater than 80%, or greater than 85%, or greater than 88% determined according to ASTM D1003 at a thickness of 1.0 millimeter, or a haze of less than 2%, or less than 1% determined according ASTM D1003 at a thickness of 1.0 millimeter.

Aspect 2: The flame retardant composition of Aspect 1 comprising 45.0-99.9 wt %, preferably 97.7-99.8 wt % of the high heat copolycarbonate, wherein the high heat bisphenol monomers comprise 1,1-bis(4-hydroxyphenyl)-3,3,5-trimethyl-cyclohexane, N-phenyl phenolphthalein bisphenol, or a combination thereof; 0.1-0.8 wt % of the C₁₋₁₆ alkyl sulfonate salt flame retardant; and optionally, 0.1-3 wt %, preferably 0.1-2 wt % of the additive composition.

Aspect 3: The flame retardant composition of any one of the preceding aspects, wherein the low heat aromatic carbonate units are present and comprise bisphenol A carbonate units.

Aspect 4: The flame retardant composition of any one of the preceding aspects, wherein the high heat bisphenol monomer comprises 15-49 mol % of N-phenyl phenolphthalein bisphenol, based on the total moles of high heat bisphenol monomer in the composition.

Aspect 5: The flame retardant composition of any one of the preceding aspects, wherein the C₁₋₁₆ alkyl sulfonate salt flame retardant is potassium perfluorobutane sulfonate, potassium perfluoroctane sulfonate, and tetraethylammonium perfluorohexane sulfonate, or a combination thereof, preferably potassium perfluorobutane sulfonate; the high heat copolycarbonate comprises N-phenyl phenolphthalein bisphenol; and the composition has a ratio of wt % of the C₁₋₁₆ alkyl sulfonate salt flame retardant to mol % of N-phenyl phenolphthalein bisphenol from 0.005-0.017, wherein the wt % of the C₁₋₁₆ alkyl sulfonate salt flame retardant is based on the total weight of the composition and the mol % of N-phenyl phenolphthalein bisphenol is based on the total moles of high heat bisphenol monomer in the composition.

Aspect 6: The flame retardant composition of any one of the preceding aspects, wherein the additive composition is present and comprises an impact modifier, a flow modifier, an antioxidant, a heat stabilizer, a light stabilizer, an ultraviolet light stabilizer, an ultraviolet absorbing additive, a plasticizer, a lubricant, a release agent, an antistatic agent, an anti-fog agent, an antimicrobial agent, a colorant, a surface effect additive, a radiation stabilizer, a flame retardant different from the C₁₋₁₆ alkyl sulfonate salt flame retardant, an anti-drip agent, or a combination thereof.

Aspect 7: The flame retardant composition of Aspect 6, wherein the flame retardant different from the C₁₋₁₆ alkyl sulfonate salt flame retardant is an organophosphorous flame retardant comprising a phosphazene, phosphate, phosphite, phosphonate, phosphinate, phosphine oxide, phosphine, or a combination thereof, preferably comprising an aromatic group.

Aspect 8: The flame retardant composition of any one of the preceding aspects comprising: 96.7-99.8 wt % of the high heat copolycarbonate, wherein the high heat bisphenol monomers of the high heat copolycarbonate comprise 1,1-bis(4-hydroxyphenyl)-3,3,5-trimethyl-cyclohexane, N-phenyl phenolphthalein bisphenol, or a combination thereof; 0.1- 0.8 wt % of potassium perfluorobutane sulfonate as the C₁₋₁₆ alkyl sulfonate salt flame retardant; and 0.1-3 wt % of the additive composition.

Aspect 9: The flame retardant composition of any one of the preceding aspects, wherein the organosulfonic stabilizer is present and comprises a C₁₋₁₀ alkyl ester of a C₇₋₁₂ alkylarylene sulfonic acid, preferably of p-toluene sulfonic acid, more preferably a C₁₋₆ alkyl ester of p-toluene sulfonic acid, even more preferably butyl tosylate.

Aspect 10: The flame retardant composition of any one of the preceding aspects, wherein a bisphenol A homopolycarbonate as the homopolycarbonate is present and has a weight average molecular weight from 18,000-35,000 grams/mole, preferably 20,000-25,000 grams/mole; a weight average molecular weight from 25,000-35,000 grams/mole, preferably 27,000-32,000 grams/mole; or a combination thereof, each as measured via gel permeation chromatography using polystyrene standards and calculated for polycarbonate.

Aspect 11: The flame retardant composition of any one of the preceding aspects having a bromine or chlorine content, or a combined bromine and chlorine content of less than or equal to 100 parts per million by weight, less than or equal to 75 parts per million by weight, or less than or equal to 50 parts per million by weight, each based on the total parts by weight of the composition.

Aspect 12: The flame retardant composition of any one of the preceding aspects, wherein a molded sample of the flame retardant composition has a heat deformation temperature greater than 155° C., preferably greater than 160° C., more preferably greater than 165° C., most preferably greater than 170° C., determined according to the ISO-75 standard using a 5.5 joule hammer on 4 millimeter-thick sample bar and a load of 1.8 megapascals.

Aspect 13: An article comprising the flame retardant composition of any one of the preceding aspects.

Aspect 14: The article of Aspect 13, wherein the article is a lens, a light guide, a waveguide, a collimator, an optical fiber, a window, a door, a visor, a display screen, an electronic device, a scientific or medical device, a safety shield, a fire shield, wire or cable sheathing, a mold, a dish, a tray, a screen, an enclosure, glazing, packaging, a gas barrier, an anti-fog layer, or an anti-reflective layer.

Aspect 15: A method for forming the article according to Aspect 13 or Aspect 14, comprising molding, casting, or extruding the composition to provide the article.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other (e.g., ranges of “up to 25 wt %, or, more specifically, 5 wt % to 20 wt %”, is inclusive of the endpoints and all intermediate values of the ranges of “5 wt % to 25 wt %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments. A “combination thereof” is open and includes any combination comprising at least one of the listed components or properties optionally together with a like or equivalent component or property not listed

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

The term “alkyl” means a branched or straight chain, unsaturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O-), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo groups (e.g., bromo and fluoro), or only chloro groups can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl)a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A flame retardant composition comprising:

45.0-99.9 wt % of a high heat copolycarbonate comprising high heat carbonate units derived from high heat bisphenol monomers comprising 1,1-bis(4-hydroxyphenyl)-3,3,5-trimethyl-cyclohexane, N-phenyl phenolphthalein bisphenol, 4,4′-(1-phenylethylidene)bisphenol, 4,4′-(3,3-dimethyl-2,2-dihydro-1H-indene-1,1-diyl)diphenol, 1,1-bis(4-hydroxyphenyl)cyclododecane, 3,8-dihydroxy-5a,10b-diphenyl-coumarano-2′,3′,2,3-coumarane, or a combination thereof, preferably 1,1-bis(4-hydroxyphenyl)-3,3,5-trimethyl-cyclohexane, N-phenyl phenolphthalein bisphenol, or a combination thereof, and optionally comprising low heat carbonate units, wherein a homopolycarbonate of the low heat carbonate units has a glass transition temperature of up to 150° C. as determined by differential scanning calorimetry as per ASTM D3418 with heating rate of 20° C./min;
0-55 wt % of a homopolycarbonate;
0.1-0.8 wt % of a C₁₋₁₆ alkyl sulfonate salt flame retardant;
optionally, 2-40 parts per million of an organosulfonic stabilizer of the formula 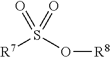
wherein
R⁷ is a C₁₋₃₀ alkyl, C₆₋₃₀ aryl, C₇₋₃₀ alkylarylene, C₇₋₃₀ arylalkylene, or a polymer unit
derived from a C₂₋₃₂ ethylenically unsaturated aromatic sulfonic acid or its ester,
R⁸ is hydrogen, C₁₋₃₀ alkyl; or a group of the formula —S(═O)_{2—}R⁷;
optionally, 0.1-5 wt % of an additive composition,
wherein the amount of the high heat copolycarbonate, the C₁₋₁₆ alkyl sulfonate salt flame retardant, the homopolycarbonate, the optional organosulfonic stabilizer and the optional additive composition is based on the total weight of the flame retardant composition, which sums to 100 wt %;
wherein a molded sample of the flame retardant composition has
a UL 94 rating of V0 at a thickness of 1.5 millimeter, and
a transmission of greater than 80%, determined according to ASTM D1003 at a thickness of 1.0 millimeter, or
a haze of less than 2%, determined according ASTM D1003 at a thickness of 1.0 millimeter.

2. The flame retardant composition of claim 1 comprising
45.0-99.9 wt % of the high heat copolycarbonate, wherein the high heat bisphenol monomer comprise 1,1-bis(4-hydroxyphenyl)-3,3,5-trimethyl-cyclohexane, N-phenyl phenolphthalein bisphenol, or a combination thereof;
0.1-0.8 wt % of the C₁₋₁₆ alkyl sulfonate salt flame retardant; and
optionally, 0.1-3 wt %, of the additive composition.

3. The flame retardant composition of claim 1, wherein the low heat aromatic carbonate units are present and comprise bisphenol A carbonate units.

4. The flame retardant composition of claim 1, wherein the high heat bisphenol monomer comprises 15-49 mol % N-phenyl phenolphthalein bisphenol, based on the total moles of high heat bisphenol monomer in the composition.

5. The flame retardant composition of claim 1, wherein
the C₁₋₁₆ alkyl sulfonate salt flame retardant is potassium perfluorobutane sulfonate, potassium perfluoroctane sulfonate, and tetraethylammonium perfluorohexane sulfonate, or a combination thereof;
the high heat copolycarbonate comprises N-phenyl phenolphthalein bisphenol; and
the composition has a ratio of wt % of the C₁₋₁₆ alkyl sulfonate salt flame retardant to mol % of N-phenyl phenolphthalein bisphenol from 0.005-0.017, wherein the wt % of the C₁₋₁₆ alkyl sulfonate salt flame retardant is based on the total weight of the composition and the mol % of N-phenyl phenolphthalein bisphenol is based on the total moles of high heat bisphenol monomer in the composition.

6. The flame retardant composition of claim 1, wherein the additive composition is present and comprises an impact modifier, a flow modifier, an antioxidant, a heat stabilizer, a light stabilizer, an ultraviolet light stabilizer, an ultraviolet absorbing additive, a plasticizer, a lubricant, a release agent, an antistatic agent, an anti-fog agent, an antimicrobial agent, a colorant, a surface effect additive, a radiation stabilizer, a flame retardant different from the C₁₋₁₆ alkyl sulfonate salt flame retardant, an anti-drip agent, or a combination thereof.

7. The flame retardant composition of claim 6, wherein the flame retardant different from the C₁₋₁₆ alkyl sulfonate salt flame retardant is an organophosphorous flame retardant comprising a phosphazene, phosphate, phosphite, phosphonate, phosphinate, phosphine oxide, phosphine, or a combination thereof.

8. The flame retardant composition of claim 1 comprising
96.7-99.8 wt % of the high heat copolycarbonate, wherein the high heat bisphenol monomer of the high heat copolycarbonate comprise 1,1-bis(4-hydroxyphenyl)-3,3,5-trimethyl-cyclohexane, N-phenyl phenolphthalein bisphenol, or a combination thereof;
0.1-0.8 wt % of potassium perfluorobutane sulfonate as the C₁₋₁₆ alkyl sulfonate salt flame retardant; and
0.1-3 wt % of the additive composition.

9. The flame retardant composition of claim 1, wherein the organosulfonic stabilizer is present and comprises a C₁₋₁₀ alkyl ester of a C₇₋₁₂ alkylarylene sulfonic acid, preferably of p-toluene sulfonic acid, more preferably a C₁₋₆ alkyl ester of p-toluene sulfonic acid, even more preferably butyl tosylate.

10. The flame retardant composition of claim 1, wherein a bisphenol A homopolycarbonate as the homopolycarbonate is present and comprises
a bisphenol A homopolycarbonate having a weight average molecular weight from 18,000-35,000 grams/mole;
a bisphenol A homopolycarbonate having a weight average molecular weight from 25,000-35,000 grams/mole; or
a combination thereof,
each as measured via gel permeation chromatography using polystyrene standards and calculated for polycarbonate.

11. The flame retardant composition of claim 1 having a bromine or chlorine content, or a combined bromine and chlorine content of less than or equal to 100 parts per million by weight, each based on the total parts by weight of the composition.

12. The flame retardant composition of claim 1, wherein a molded sample of the flame retardant composition has a heat deformation temperature greater than 155° C., determined according to the ISO-75 standard using a 5.5 joule hammer on 4 millimeter-thick sample bar and a load of 1.8 megapascals.

13. An article comprising the flame retardant composition of claim 1.

14. The article of claim 13, wherein the article is a lens, a light guide, a waveguide, a collimator, an optical fiber, a window, a door, a visor, a display screen, an electronic device, a scientific or medical device, a safety shield, a fire shield, wire or cable sheathing, a mold, a dish, a tray, a screen, an enclosure, glazing, packaging, a gas barrier, an anti-fog layer, or an anti-reflective layer.

15. A method for forming the article according to claim 13, comprising molding, casting, or extruding the composition to provide the article.

16. The flame retardant composition of claim 1, wherein the organosulfonic stabilizer comprises a C₁₋₁₀ alkyl ester of p-toluene sulfonic acid

17. The flame retardant composition of claim 1, wherein the organosulfonic stabilizer comprises butyl tosylate.
